(19) United States
(12) Patent Application Publication
(10) Pub. No.: US 2009/0067875 A1
(43) Pub. Date: Mar. 12, 2009

(54) CHARGING DEVICE IN IMAGE FORMING APPARATUS

(75) Inventor: Eiji GUNBE, Kanagawa (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/206,235

(22) Filed: Sep. 8, 2008

Related U.S. Application Data
(60) Provisional application No. 60/971,242, filed on Sep. 10, 2007.

(51) Int. Cl. G03G 15/02

(52) U.S. Cl. 399/100

(57) ABSTRACT

According to an embodiment of the invention, cleaning sheets that contact and clean a needle electrode are caused to meander along the shape of a slit formed on a guide plate of a needle electrode charger case. Thus, a contact width on the cleaning sheets with the needle electrode is expanded. Unbalanced wear at particular positions on the cleaning sheets is prevented and the life of the cleaning sheets is extended.

### CROSS-REFERENCE TO RELATED APPLICATION

This application is based upon and claims the benefit of priority from U.S. Provisional Application Ser. No. 60/971,242 filed on Sep. 10, 2007, the entire contents of which are incorporated herein by reference.

### TECHNICAL FIELD

The present invention relates to a charging device in an image forming apparatus having a cleaning function for an electric discharging member that is used for an electrophotographic image forming apparatus.

### BACKGROUND

Generally, in an electrophotographic image forming apparatus, a charging device that provides electric charges by corona discharge is used in order to uniformly charge a photoconductive drum or to carry out transfer of a toner image and peeling of a paper sheet. While this charging device using corona discharge is being used, oxides, toner, or paper particles adhere to a wire-shaped corona discharge member or a needle-shaped corona discharge member provided on a metal plate.

When the corona discharge member of the charging device is contaminated by the adhering matter, the photoconductive drum is charged unevenly. This lowers the transfer efficiency of a toner image and may cause a defective image or a peeling error of a paper sheet. Therefore, conventionally, a cleaning member including a cleaning pad, a cleaning sheet or the like is in slide contact with the corona discharge member and is moved back and forth along the corona discharge member to clean up the adhering matter on the corona discharge member.

However, conventionally, the sliding direction of the cleaning member on the corona discharge member is parallel to the longitudinal direction of the corona discharge member. Therefore, while the cleaning member is moved back and forth along the corona discharge member, a specific part of the cleaning member is worn in an unbalanced manner. There is a risk of cleaning failure or premature breakage of the cleaning member.

Thus, it is desired that, as a charging device having a cleaning function, a charging device in an image forming apparatus is developed in which unbalanced wear of a cleaning member sliding in contact with a corona discharge member can be prevented and the life of the cleaning member can be extended.

### SUMMARY

According to an aspect of the invention, the life of a cleaning member that slides in contact with a corona discharge member and cleans up adhering matter on the corona discharge member is extended by prevention of unbalanced wear of the cleaning member.

According to an embodiment of the invention, a charging device in an image forming apparatus includes a discharge member that provides electric charges to an image carrier, a cleaning member provided slidably on the discharge member, and a moving member that holds the cleaning member to allow the cleaning member to slide in contact with the discharge member and moves the cleaning member in a longitudinal direction and a direction of width of the discharge member.

### DESCRIPTION OF THE DRAWINGS

FIG. 1 is a schematic view showing the configuration of a color copy machine according to a first embodiment of the invention;

FIG. 2 is a schematic view showing the configuration of an image forming station according to the first embodiment of the invention;

FIG. 3 is a schematic perspective view showing a charging device according to the first embodiment of the invention;

FIG. 4 is a schematic explanatory view showing a cleaning sheet according to the first embodiment of the invention;

FIG. 5 is a partial plan view of a charger case according to the first embodiment of the invention, as viewed from its bottom;

FIG. 6 is a schematic explanatory view showing a state where the cleaning sheet according to the first embodiment of the invention is away from needle-shaped protrusions;

FIG. 7 is a schematic explanatory view showing a state where the cleaning sheet according to the first embodiment of the invention is in contact with needle-shaped protrusions;

FIG. 8 is a partial plan view of a charger case according to a second embodiment of the invention, as viewed from its bottom;

FIG. 9 is a schematic explanatory view showing an area α on a guide plate according to the second embodiment of the invention, as enlarged;

FIG. 10 is a schematic explanatory view showing a state where a cleaning sheet according to the second embodiment of the invention is in contact with needle electrodes;

FIG. 11 is a schematic explanatory view showing a wire electrode and a cleaning pad according to a third embodiment of the invention; and

FIG. 12 is a schematic explanatory view showing the layout of the wire electrode according to the third embodiment of the invention.

### DETAILED DESCRIPTION

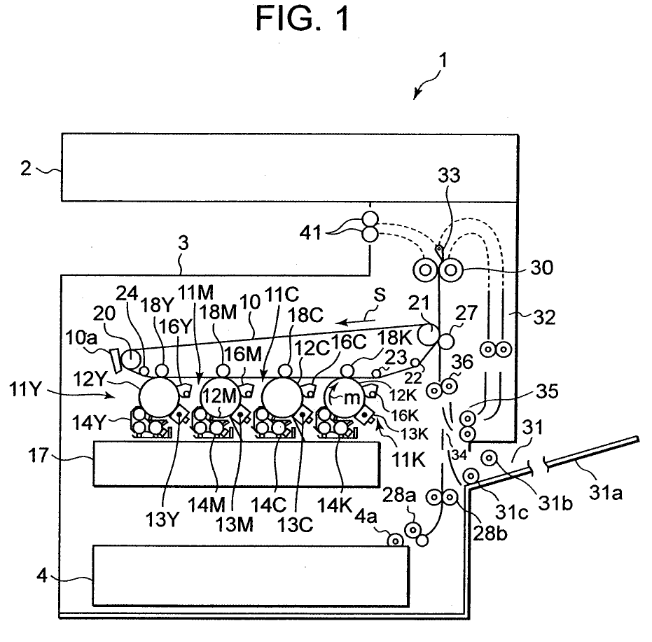

Hereinafter, a first embodiment of the invention will be described in detail with reference to the attached drawings. FIG. 1 is a schematic view of configuration showing a four-drum tandem color copy machine 1, which is an image forming apparatus according to an embodiment of the invention. The color copy machine 1 has, in its upper part, a scanner unit 2 and an internal paper discharge unit 3. The color copy machine 1 has an image forming unit 11 including four image forming stations 11Y, 11M, 11C and 11K for yellow (Y), magenta (M), cyan (C) and black (K) arranged parallel to each other along the lower side of an intermediate transfer belt 10.

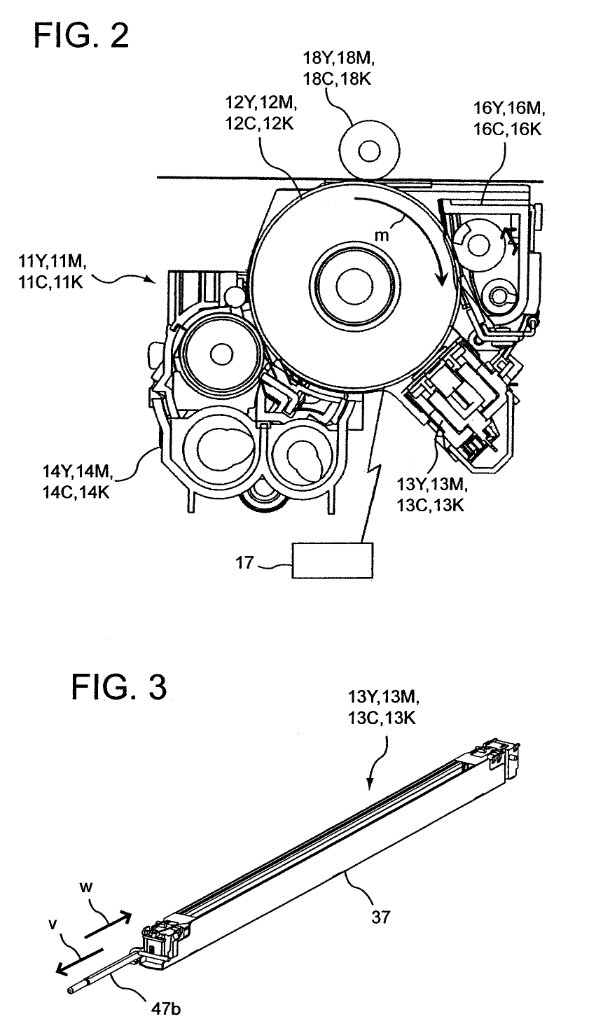

The image forming stations 11Y, 11M, 11C and 11K have photoconductive drums 12Y, 12M, 12C and 12K, respectively, as image carriers, as shown in FIG. 2. In the periphery of the each photoconductive drums 12Y, 12M, 12C and 12K, charging devices 13Y, 13M, 13C and 13K, developing devices 14Y, 14M, 14C and 14K, and photoconductor cleaning devices 16Y, 16M, 16C and 16K are arranged respectively along the rotating direction of the photoconductive drums 12Y, 12M, 12C and 12K indicated by an arrow m. Between the respective charging devices 13Y, 13M, 13C and 13K and the respective developing devices 14Y, 14M, 14C and 14K in the periphery of the each photoconductive drums 12Y, 12M, 12C and 12K, exposure light from a laser exposure device 17 is cast to form an electrostatic latent image on the each photoconductive drums 12Y, 12M, 12C and 12K.

The each developing devices 14Y, 14M, 14C and 14K have a two-component developer made of yellow (Y), magenta (M), cyan(C) or black (K) toner and a carrier respectively, and supply the toner to the electrostatic latent images on the photoconductive drums 12Y, 12M, 12C and 12K.

The intermediate transfer belt 10 is tensioned by a backup roller 21, a driven roller 20 and first to third tension rollers 22 to 24. The intermediate transfer belt 10 faces and contacts the photoconductive drums 12Y, 12M, 12C and 12K. At the positions on the intermediate transfer belt 10 that face photoconductive drums 12Y, 12M, 12C and 12K, primary transfer rollers 18Y, 18M, 18C and 18K are provided in order to carry out primary transfer of the toner images on the each photoconductive drums 12Y, 12M, 12C and 12K to the intermediate transfer belt 10.

In a secondary transfer section, which is a transfer position on the intermediate transfer belt 10 supported by the backup roller 21, a secondary transfer roller 27 is arranged. In the secondary transfer section, a predetermined secondary transfer bias is applied to the backup roller 21. As a paper sheet as a recording medium passes between the intermediate transfer belt 10 and the secondary transfer roller 27, the toner images on the intermediate transfer belt 10 are secondary-transferred onto the paper sheet. After the secondary transfer ends, the intermediate transfer belt 10 is cleaned by a belt cleaner 10a.

Below the laser exposure device 17, a paper supply cassette 4 is provided that supplies a paper sheet toward the secondary transfer roller 27. On the right side of the color copy machine 1, a manual insertion mechanism 31 is provided that supplies a paper sheet by manual insertion.

Between the paper supply cassette 4 and the secondary transfer roller 27, a pickup roller 4a, a separation roller 28a, carrying rollers 28b and a registration roller pair 36 are provided. Between a manual insertion tray 31a of the manual insertion mechanism 31 and the registration roller pair 36, a manual insertion pickup roller 31b and a manual insertion separation roller 31c are provided. Moreover, a fixing device 30 that fixes, by heat treatment, the toner images transferred onto the paper sheet in the secondary transfer section, is provided along the direction of a vertical carrying path 34 and downstream of the secondary transfer section. Downstream of the fixing device 31, a gate 33 is provided that allocates the paper sheet into the direction of paper discharge rollers 41 or into the direction of a re-carrying unit 32. The paper sheet led to the paper discharge rollers 41 is discharged to the internal paper discharge unit 3. Meanwhile, the paper sheet led to the re-carrying unit 32 is led again to the direction of the secondary transfer roller 27.

The image forming station 11Y has the photoconductive drum 12Y integrated with a process unit. The image forming station 11Y is provided in a manner of being attachable to and removable from the body of the color copy machine 1. The process unit refers to at least one of the charging device 13Y, the developing device 14Y and the photoconductor cleaning device 16Y. The image forming stations 11M, 11C and 11K have a configuration similar to that of the image forming station 11Y. Each of the image forming stations 11Y, 11M, 11C and 11K may be separately attachable to and removable from the body of the color copy machine 1. Alternatively, the image forming stations 11Y, 11M, 11C and 11K may be attachable to and removable from the body of the color copy machine 1 as the integrated image forming unit 11.

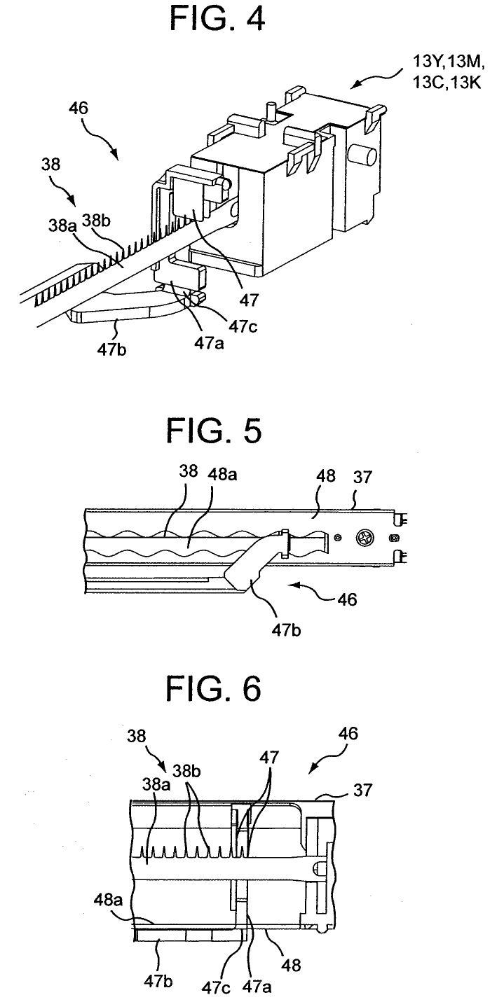

Next, the charging devices 13Y, 13M, 13C and 13K will be described in detail. Since the charging devices 13Y, 13M, 13C and 13K have the same structure, common reference numerals will be used in the description. Each of the charging devices 13Y, 13M, 13C and 13K has a needle electrode 38 serving as a discharge member in a charger case 37 serving as a case to provide electric charges to the photoconductive drums 12Y, 12M, 12C and 12K, as shown in FIG. 3 and FIG. 4. The needle electrode 38 has plural needle-shaped protrusions 38b in the longitudinal direction of the charger case 37. The needle electrode 38 includes a thin metal plate 38a with the needle-shaped protrusions 38b provided thereon, and carries out corona discharge from the distal end of the needle-shaped protrusions 38b.

Each of the charging devices 13Y, 13M, 13C and 13K has an electrode cleaning device 46 that cleans up stains and dust made of oxide formed by ozone adhering to the needle electrode 38, floating toner, paper particles and so on.

The electrode cleaning device 46 has double cleaning sheets 47 as a cleaning member slide in contact with the distal end of the needle-shaped protrusions 38b of the needle electrode 38 and thus removes the stains and dust adhering to the needle electrode 38. The cleaning sheets 47 are held by a bracket 47a, which is a holding member constituting a moving member. The bracket 47a is fixed to a handle 47b serving as an operating unit, for example, for a serviceman to manually slide the cleaning sheets 47.

A guide plate 48 shown in FIG. 5, which is a guide member, is provided on the bottom side of the charger case 37. On the guide plate 48, a meandering slit 48a having, for example, a substantially sine-curve shape, is formed. The bracket 47a is fixed to the handle 47b through the slit 48a. A slide part 47c of the bracket 47a has substantially the same width as the width of the slit 48a. The slide part 47c is fitted in the slit 48a. Therefore, when the bracket 47a is slid in the longitudinal direction of the charger case 37, the bracket 47a and the cleaning sheets 47 supported by the bracket 47a are caused to meander along the sine-curve shape of the slit 48a.

As the slit 48a is thus formed on the guide plate 48, the bottom side of the charger case 37 is connected to outside. However, since the needle electrode 38 is discharged in the direction of the needle-shaped protrusions 38b, electric charges discharged from the needle electrode 38 are not influenced by the slit 48a.

Next, the operation will be described. While the each image forming stations 11Y, 11M, 11C and 11K are installed in the body of the color copy machine 1 and image formation is carried out, the cleaning sheets 47 in the electrode cleaning device 46 is stopped at the initial position on the rear end side of the color copy machine 1. Thus, the end of the handle 47b is housed in the body of the color copy machine 1 instead of protruding largely forward.

During the execution of an image forming process in this state, stains and dust adhere to the needle electrodes 38 of the charging devices 13Y, 13M, 13C and 13K respectively. If these stains and dust are left adhering to the needle electrodes, they cause uneven discharge and charging irregularity, which in turn causes deterioration in image quality. Thus, a serviceman or an operator cleans the needle electrode 38 by using the electrode cleaning devices 46 at predetermined timing set in advance, or when necessary.

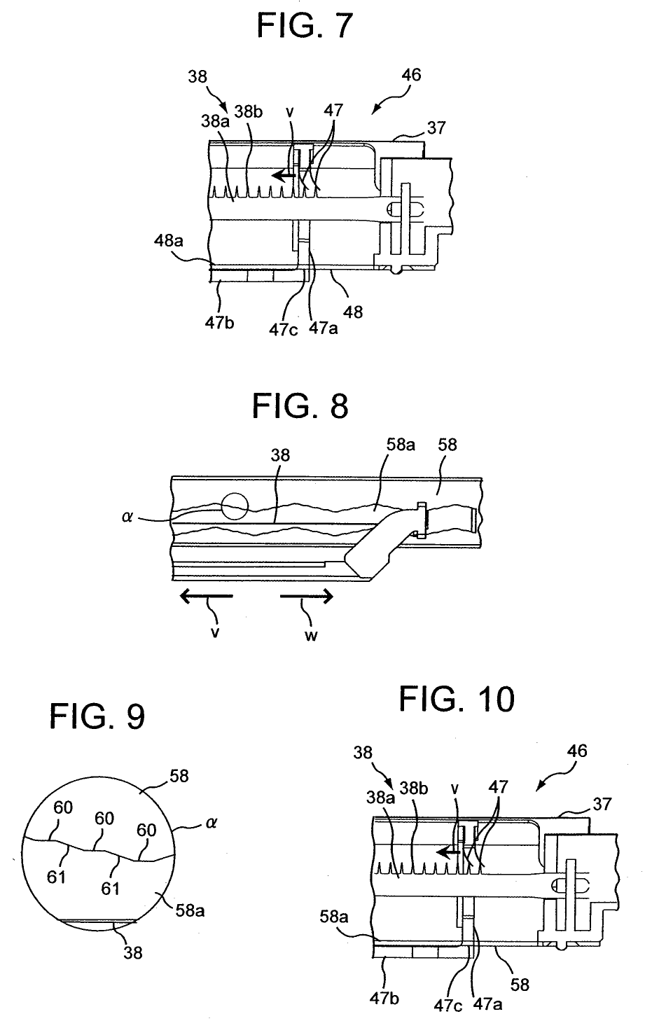

In the cleaning operation, the front cover of the color copy machine 1 is opened and the end of the handle 47b protruding to the front side from each of the charging devices 13Y, 13M, 13C and 13K is pulled into the direction of an arrow v. Thus, the cleaning sheets 47 held by the bracket 47a slide in the direction of the arrow v in the charger case 37 while repeating sliding into contact with and away from the distal ends of the needle-shaped protrusions 38b of the needle electrode 38. Thus, the cleaning sheets 47 clean up the adhering matter on the needle electrode 38. FIG. 6 shows the state where the cleaning sheets 47 exist between neighboring needle-shaped protrusions 38b of the needle electrode 38 and are away from the needle-shaped protrusions 38b. FIG. 7 shows the state where the cleaning sheets 47 are in contact with the needle-shaped protrusions 38b.

When the cleaning sheets 47 slide in the direction of the arrow v, the bracket 47a is regulated by the shape of the slit 48a formed on the guide plate 48 and moves along the slit 48a. Therefore, also the cleaning sheets 47 held by the bracket 47a meander along the shape of the slit 48a and move in the longitudinal direction and in the direction of width of the charger case 37. Thus, a contact width expands, which is the range in which the cleaning sheets 47 contact the distal ends of the needle-shaped protrusions 38b of the needle electrode 38. The contact width of the cleaning sheets 47 and the distal ends of the needle-shaped protrusions 38b is equivalent to the moving width in the direction of width of the slit 48a formed on the guide plate 48.

When the cleaning sheets 47 are slid to the front end of each of the charging devices 13Y, 13M, 13C and 13K, the handle 47b is slid in the direction of an arrow w and the cleaning sheets 47 are returned to the initial position shown in FIG. 6. Then, the cleaning of the needle electrodes 38 ends. The cleaning sheets 47 meander along the shape of the slit 48a when the cleaning sheets 47 are being returned to the initial position as well. It is also possible to slide the cleaning sheets 47 multiple times in the longitudinal direction of the charger case 37, when necessary.

According to the first embodiment, the bracket 47a is slid along the sine-curved slit 48a formed on the guide plate 48. This causes the cleaning sheets 47 to slide in contact with the distal ends of the needle-shaped protrusions 38b while meandering in the sine-curve shape when cleaning the needle electrode 38. Thus, the area on the cleaning sheets 47 contacted by the needle-shaped protrusions 38b expands. Consequently, cleaning failure and damage to the cleaning sheets 47 due to unbalanced wear at particular positions on the cleaning sheets 47 by the needle-shaped protrusions 38b can be prevented, and the life of the cleaning sheets 47 can be extended.

Next, a second embodiment of the invention will be described. In the second embodiment, the shape of the guide member is different from that of the first embodiment. The other parts of the configuration are the same as in the first embodiment. Therefore, in the second embodiment, the same parts of the configuration as those described in the first embodiment are denoted by the same reference numerals and will not be described further in detail.

In the second embodiment, the inclination of a slit 58a formed on a guide plate 58 is changed in accordance with the position of the needle-shaped protrusions 38b of the needle electrode 38, as shown in FIG. 8. That is, an area 60 parallel to the needle electrode 38 and an area 61 inclined with respect to the longitudinal direction of the needle electrode 38 are formed on the outer periphery of the slit 58a, as shown in FIG. 9 showing an enlarged view of an area α shown in FIG. 8.

When the cleaning sheets 47 are slid in the longitudinal direction of the needle electrode 38, the cleaning sheets 47 are prevented from moving in the direction of width while the cleaning sheets 47 are in contact with a needle-shaped protrusion 38b, for example, as shown in FIG. 10. That is, during this time, the bracket 47a holding the cleaning sheets 47 is guided by the area 60 parallel to the needle electrode 38, of the slit 58a. Then, until the cleaning sheets 47 come to slide in contact with the next neighboring needle-shaped protrusion 38b after the cleaning sheets 47 are detached from the needle-shaped protrusions 38b, the cleaning sheets 47 are moved in the direction of width. That is, during this time, the bracket 47a holding the cleaning sheets 47 is guided by the area 61 inclined with respect to the longitudinal direction of the needle electrode 38, of the slit 58a.

Thus, the cleaning sheets 47 move obliquely with respect to the longitudinal direction of the needle electrode 38 only when the cleaning sheets 47 are located in an intermediate area between the neighboring needle-shaped protrusions 38b and 38b and away from the needle-shaped protrusions 38b. On the other hand, when the cleaning sheets 47 are in contact with the needle-shaped protrusions 38b, the cleaning sheets 47 move parallel to the longitudinal direction of the needle electrode 38. That is, on the cleaning sheets 47, the sliding contact position to an arbitrary needle-shaped protrusion 38b and the sliding contact position to the next neighboring needle-shaped protrusion 38b are sequentially moved in the direction of width. However, while the cleaning sheets 47 are sliding in contact with an arbitrary needle-shaped protrusion 38b, the sliding contact position on the cleaning sheets 47 is not moved in the direction of width.

According to the second embodiment, as in the first embodiment, since the cleaning sheets 47 are slid along the slit 58a formed on the guide plate 58, the contact area on the cleaning sheets 47 with the needle-shaped protrusions 38b expands when cleaning the needle electrode 38. Consequently, unbalanced wear at particular positions on the cleaning sheets 47 does not occur and the life of the cleaning sheets 47 can be extended. Moreover, according to the second embodiment, when in contact with the needle-shaped protrusions 38b, the cleaning sheets 47 move parallel to the longitudinal direction in which the plural needle-shaped protrusions 38b are arrayed. Therefore, no oblique force is applied to the needle-shaped protrusions 38b by the cleaning sheets 47. Consequently, there is no possibility of deformation of the distal ends of the needle-shaped protrusions 38b.

Next, a third embodiment of the invention will be described. In the third embodiment, the discharge member in the first embodiment is modified into a wire shape and adhering matter on the discharge member is wiped off by a cleaning pad. The other parts of the configuration are the same as in the first embodiment. Therefore, in the third embodiment, the same parts of the configuration as those described in the first embodiment are denoted by the same reference numerals and will not be described further in detail.

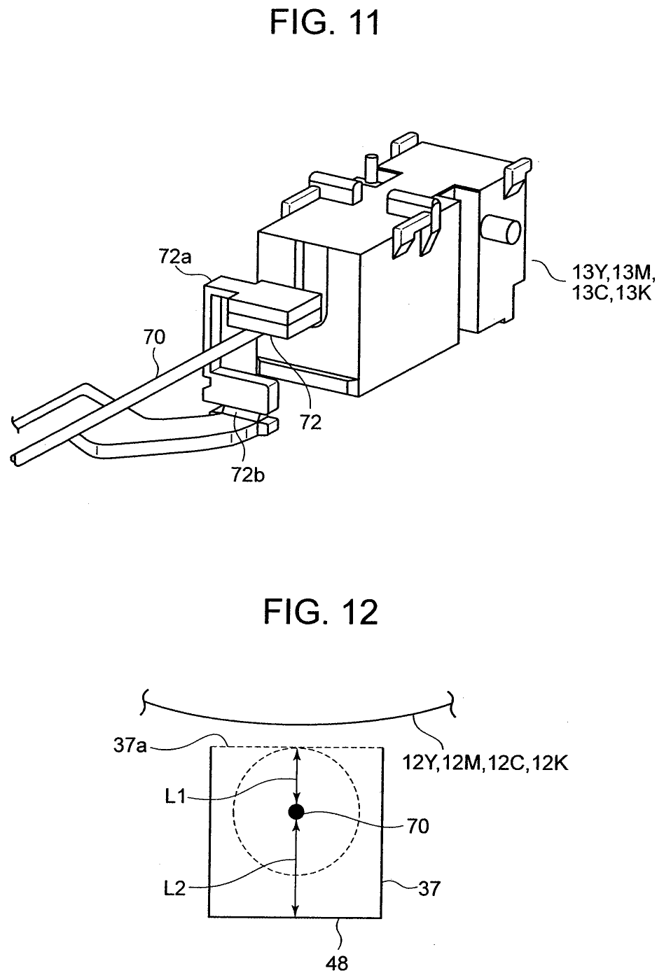

In the third embodiment, a wire electrode 70, which is a wire-shaped discharge member, is provided in the charger case 37 of each of the charging devices 13Y, 13M, 13C and 13K, as shown in FIG. 11. An electrode cleaning device 71 for removing adhering matter on the wire electrode 70 has, for example, a felt-like cleaning pad 72 serving as a cleaning member. The cleaning pad 72 slides in contact with the wire electrode 70 and wipes the adhering matter off. A slide part 72b of a bracket 72a holding the cleaning pad 72 is fitted in the meandering slit 48a on the guide plate 48 arranged on the bottom side of the charger case 37. The cleaning pad may also be grinder to grind the adhering matter off.

The arrangement position of the wire electrode 70 in the charger case 37 is as shown in FIG. 12. That is, when the distance from a grid electrode 37a provided on a surface of the charger case 37 facing the each photoconductive drums 12Y, 12M, 12C and 12K to the wire electrode 70 is L1 and the distance from the wire electrode 70 to the guide plate 48 is L2, L2>L1 holds.

Since the wire electrode 70 is arranged in this manner, electric charges discharged concentrically from the wire electrode 70 are controlled by the grid electrode 37a and provided to the photoconductive drums 12Y, 12M, 12C and 12K before being influenced by the slit 48a of the guide plate 48.

In the cleaning operation for the wire electrode 70, as in the first embodiment, the end of the handle 47b is pulled into the direction of the arrow v. Thus, the bracket 72a, which is located on the rear side of the color copy machine 1 as the initial position, moves in the direction of the arrow v while meandering along the shape of the slit 48a formed on the guide plate 48. Also the cleaning pad 72 held by the bracket 72a slides in the direction of the arrow v while meandering. The cleaning pad 72 wipes the adhering matter off the wire electrode 70 while sliding in contact with the wire electrode 70. The backward movement of the cleaning pad 72 is similarly carried out. As the handle 47b is slid in the direction of the arrow w, the cleaning pad 72 moves backward in the direction w while meandering, and then is returned to the initial position on the rear side of the color copy machine 1.

Thus, when cleaning the wire electrode 70, the contact width with the wire electrode 70 on the cleaning pad 72 expands.

According to the third embodiment, as in the first embodiment, since the cleaning pad 72 is slid along the slit 48a formed on the guide plate 48, the contact area on the cleaning pad 72 with the wire electrode 70 increases. Consequently, unbalanced wear at particular positions on the cleaning pad 72 does not occur and the life of the cleaning pad 72 can be extended.

The invention is not limited to the above embodiments. Various changes and modifications can be made without departing from the scope and spirit of the invention. For example, the corona discharge member used in the image forming apparatus is not limited to the charging device, and a transfer charger, a separating charger or the like may also be used. The form of the corona discharge member is arbitrary. The image forming apparatus may also be a monochrome copy machine and so on. Moreover, the moving member may be arbitrary as long as it is capable of moving the cleaning member in the longitudinal direction and in the direction of width. A driving member such as a motor may be provided to automatically move the cleaning member. Also, the guide member may be in the form of a rail instead of forming a slit on the guide plate, and the shape of the slit and rail is not limited, either.

What is claimed is:

1. A charging device in an image forming apparatus comprising:
a discharge member that provides electric charges to an image carrier;
a cleaning member provided slidably on the discharge member; and
a moving member that holds the cleaning member to allow the cleaning member to slide in contact with the discharge member and moves the cleaning member in a longitudinal direction and in a direction of width of the discharge member.

2. The device according to claim 1, wherein the movement of the moving member in the longitudinal direction and in the direction of width is a meandering movement.

3. The device according to claim 1, wherein the moving member has a holding member that holds the cleaning member, and a guide member that regulates movement of the holding member.

4. The device according to claim 3, wherein the guide member is a guide plate that is provided on a case housing the discharge member and that has a meandering slit formed thereon, and the holding member is fit in the slit.

5. The device according to claim 1, wherein the discharge member has plural needle-shaped protrusions arrayed in the longitudinal direction.

6. The device according to claim 5, wherein the moving member moves the cleaning member obliquely with respect to the longitudinal direction between an arbitrary one of the needle-shaped protrusions and a next protrusion, and moves the cleaning member parallel to the longitudinal direction when contacting the needle-shaped protrusions.

7. The device according to claim 5, wherein the moving member has a holding member that holds the cleaning member, and a guide plate that is provided on a bottom side of a case housing the discharge member and that has a meandering slit formed thereon, and
the holding member is fit in the slit.

8. The device according to claim 1, wherein the discharge member is a wire-shaped,
the moving member has a holding member that holds the cleaning member, and a guide plate that is provided at a position on side of a case housing the wire-shaped discharge member and supporting a grid electrode, the side facing the grid electrode, with a distance L2 from the position to the wire-shaped discharge member being longer than a distance L1 from the wire-shaped discharge member to the grid electrode, the guide plate having a meandering slit formed thereon, and
the holding member is fit in the slit.

9. The device according to claim 1, wherein the moving member has an operating unit configured to move the cleaning member manually.

10. An image forming apparatus comprising:
an image carrier;
an image forming unit configured to expose light to the image carrier uniformly charged by a discharge member that provides electric charges, develop a formed electrostatic latent image, and form a toner image on the image carrier;
a cleaning member provided slidably on the discharge member; and
a moving member that holds the cleaning member to allow the cleaning member to slide in contact with the discharge member and moves the cleaning member in a longitudinal direction and in a direction of width of the discharge member.

11. The apparatus according to claim 10, wherein the moving member has a holding member that holds the cleaning member, and a guide member that regulates movement of the holding member.

12. The apparatus according to claim 11, wherein the guide member is a guide plate that is provided on a case housing the discharge member and that has a meandering slit formed thereon, and the holding member is fit in the slit.

13. The apparatus according to claim 10, wherein the discharge member has plural needle-shaped protrusions arrayed in the longitudinal direction.

14. The apparatus according to claim 13, wherein the moving member moves the cleaning member obliquely with respect to the longitudinal direction between an arbitrary one of the needle-shaped protrusions and a next protrusion, and moves the cleaning member parallel to the longitudinal direction when contacting the needle-shaped protrusions.

15. The apparatus according to claim 13, wherein the moving member has a holding member that holds the cleaning member, and a guide plate that is provided on a bottom side of a case housing the discharge member and that has a meandering slit formed thereon, and
the holding member is fit in the slit.

16. The apparatus according to claim 10, wherein the discharge member is a wire-shaped,
the moving member has a holding member that holds the cleaning member, and a guide plate that is provided at a position on a side of a case housing the wire-shaped discharge member and supporting a grid electrode, the side facing the grid electrode, with a distance L2 from the position to the wire-shaped discharge member being longer than a distance L1 from the wire-shaped discharge member to the grid electrode, the guide plate having a meandering slit formed thereon, and
the holding member is fit in the slit.

17. The apparatus according to claim 10, wherein the moving member has an operating unit configured to move the cleaning member manually.

18. A cleaning method for a charging device comprising:
holding a cleaning member in contact with a discharge member; and
moving the cleaning member in a longitudinal direction of the discharge member while causing the cleaning member to meander.

19. The method according to claim 18, wherein the meandering of the cleaning member is carried out as the cleaning member is guided by a guide plate having a meandering slit formed thereon.

20. The method according to claim 18, wherein when the discharge member has plural needle-shape protrusions arrayed in the longitudinal direction,
the meandering of the cleaning member includes repetition of oblique movement of the cleaning member between an arbitrary one of the needle-shaped protrusions and a next protrusion and movement of the cleaning member parallel to the longitudinal direction when contacting the needle-shaped protrusions.
